(19) United States
(12) Patent Application Publication
(10) Pub. No.: US 2016/0090981 A1
(43) Pub. Date: Mar. 31, 2016

(54) PORTABLE HYDRATION SYSTEM USABLE WITH A PROTECTIVE HELMET

(71) Applicant: Gerald M. Ryan, Dolores, CO (US)

(72) Inventor: Gerald M. Ryan, Dolores, CO (US)

(21) Appl. No.: 14/614,541

(22) Filed: Feb. 5, 2015

Related U.S. Application Data
(60) Provisional application No. 62/056,022, filed on Sep. 26, 2014.

(51) Int. Cl. F04B 49/06; G05D 7/06

(52) U.S. Cl. CPC F04B 49/065; G05D 7/0635

(57) ABSTRACT

A portable hydration system, including first and second control assemblies. The first control assembly includes: a pump with an input arranged to connect to a fluid supply; a control unit configured to receive a wireless signal and control operation of the pump according to the wireless signal; and at least one power supply for the pump and the controller. The second control assembly includes: a wireless transmitter arranged to transmit the wireless signal; and a switch arranged for mounting on a vehicle and to control operation of the wireless transmitter.

### CROSS-REFERENCE TO RELATED APPLICATIONS

This application claims the benefit of U.S. Provisional Patent Application No. 62/056,022, filed Sep. 26, 2014, which application is incorporated herein by reference in its entirety.

### TECHNICAL FIELD

The disclosure relates generally to a portable hydration system usable with a protective helmet, in particular, an assembly including power and water supplies, a pump, and wireless receiver/control unit and a remote assembly for triggering the pump connected via wireless communication.

### BACKGROUND

It is desirable to provide hydration while a motorcycle or bicycle is being ridden. Known systems include a “camelback” arrangement in which a water/fluid supply is carried by the rider and a hose connects a nozzle. In one instance, to obtain water/fluid, the rider must keep the nozzle in their mouth the entire time while riding, which is extremely uncomfortable. In another instance, to obtain water/fluid, the rider must use one hand to place the nozzle in the rider's mouth and then use the hand to remove the nozzle. Removing a hand during riding can be hazardous or can degrade the rider's performance, for example, requiring the rider to slow down during a race.

### SUMMARY

According to aspects illustrated herein, there is provided a portable hydration system, including first and second control assemblies. The first control assembly includes: a pump with an input arranged to connect to a fluid supply; a control unit configured to receive a wireless signal and control operation of the pump according to the wireless signal; and at least one power supply for the pump and the controller. The second control assembly includes: a wireless transmitter arranged to transmit the wireless signal; and a switch arranged for mounting on a vehicle and to control operation of the wireless transmitter.

According to aspects illustrated herein, there is provided a portable hydration system, including a hydration assembly with: a fluid supply; a first control assembly including a pump arranged to connect to the fluid supply, a control unit configured to receive a wireless signal and control operation of the pump according to the wireless signal; at least one power supply for the pump and the controller; and a dispensing assembly connected to the pump. The portable hydration system includes a second control assembly with: a wireless transmitter arranged to transmit the wireless signal; and a switch arranged for mounting on a vehicle and to control operation of the wireless transmitter.

According to aspects illustrated herein, there is provided a portable hydration system, including: a protective helmet; a first control assembly; a dispensing assembly; and a second control assembly. The first control assembly includes: a pump with an input arranged to connect to a fluid supply; a control unit configured to receive a wireless signal and control operation of the pump according to the wireless signal; and at least one power supply for the pump and the controller. The dispensing assembly is connected to the pump and the protective helmet. The second control assembly includes: a wireless transmitter arranged to transmit the wireless signal; and a switch arranged for mounting on a vehicle and to control operation of the wireless transmitter.

### BRIEF DESCRIPTION OF THE DRAWINGS

The nature and mode of operation of the disclosure will now be more fully described in the following detailed description of the disclosure taken with the accompanying figures, in which:

FIG. 1 is a schematic block diagram of a portable hydration system;

FIG. 2 is a schematic block diagram of an example deployment of the portable hydration system shown in FIG. 1;

FIG. 3 is a schematic block diagram of an example deployment of the portable hydration system shown in FIG. 1;

FIG. 4 is a pictorial representation of an example configuration of the control assembly shown in FIG. 1; and,

FIG. 5 is a pictorial representation of the system of FIG. 1 in use on a motorcycle rider.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

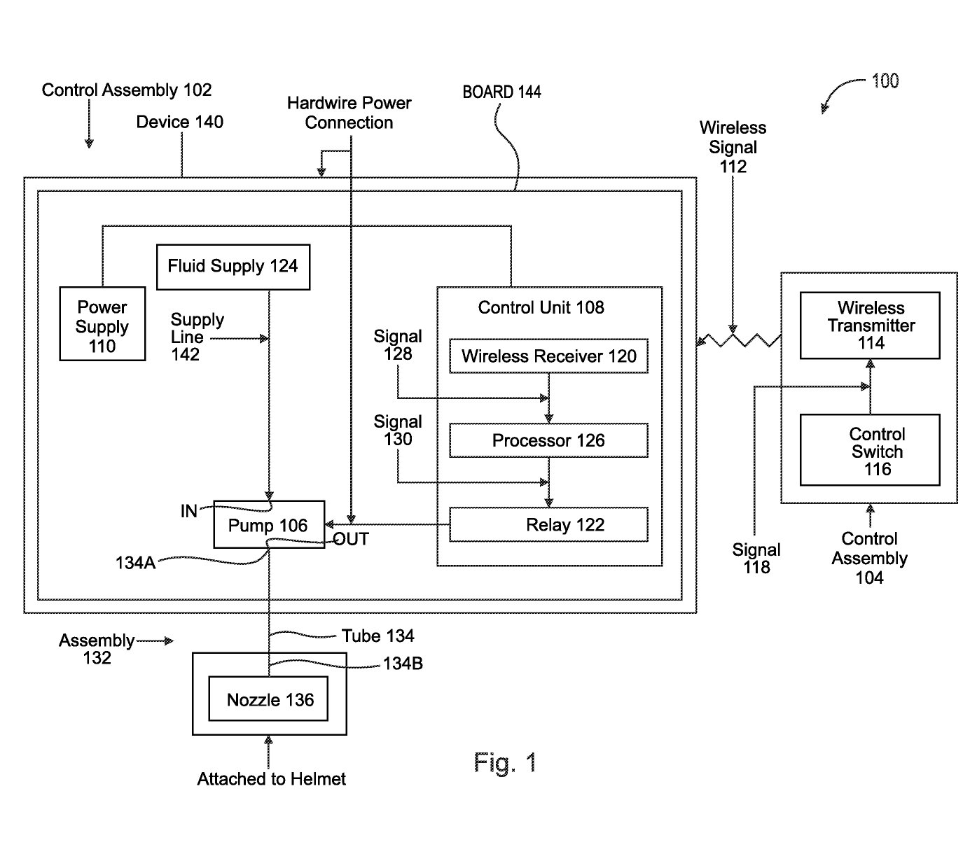

FIG. 1 is a schematic block diagram of portable hydration system 100.

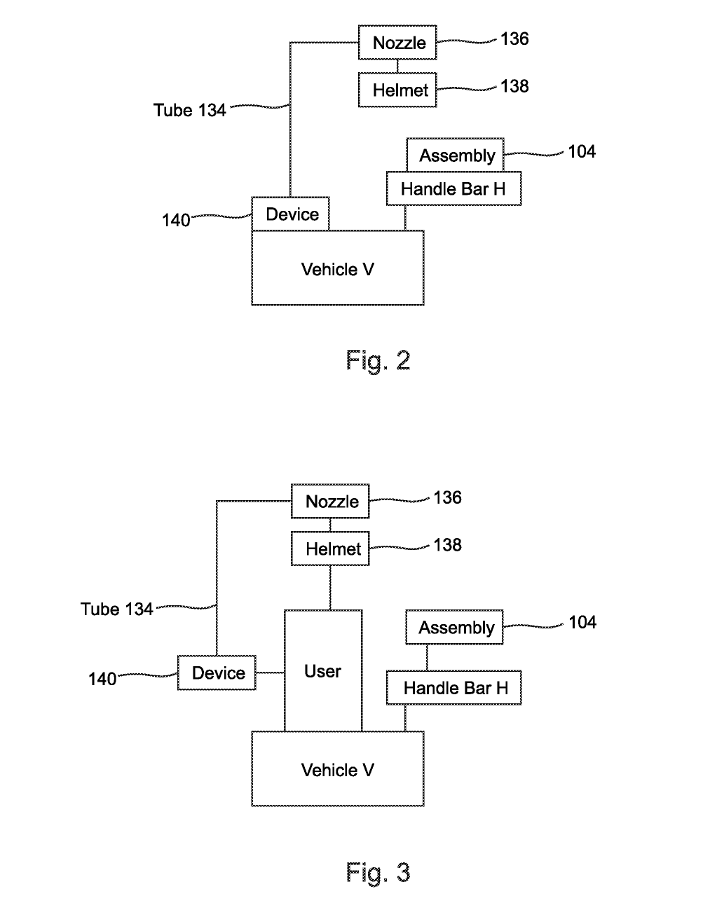

FIG. 2 is a schematic block diagram showing an example deployment of system 100 in FIG. 1.

FIG. 3 is a schematic block diagram showing an example deployment of system 100 in FIG. 1. The following should be viewed in light of FIGS. 1 through 3. System 100 includes control assembly 102 and control assembly 104. Assembly 102 includes pump 106, control unit 108 and power supply 110 for pump 106 and control unit 108. Control unit 108 is configured to receive wireless signal 112 and control operation of pump 106 according to wireless signal 112. Control assembly 104 includes: wireless transmitter 114 arranged to transmit wireless signal 112; and switch 116 arranged for mounting on vehicle V, for example to handle bars H for a motorcycle or a bicycle. Switch 116 is configured to control operation of wireless transmitter 114. For example, closing switch 116 sends control signal 118 to transmitter 114 and upon receipt of signal 118, transmitter 114 transmits signal 112.

Control unit 108 includes wireless receiver 120 configured to receive wireless signal 112. In an example embodiment, control unit 108 includes power relay 122 connecting pump 106 to power supply 110. Control unit 108 is configured to operate relay 122 to energize the pump upon receipt of signal 112. In an example embodiment, relay 122 is normally open to prevent pumping fluid from fluid supply 124 in the event of loss of power to the relay. Control unit 108 is configured to close relay 122 to operate pump 106. In an example embodiment, control unit 108 includes processor 126. Receiver 118 is configured to transmit signal 128 to processor 126 upon receipt of signal 112. Process 126 is configured to transmit control signal 130 to relay 122 upon receipt of signal 128. Relay 122 is configured to close upon receipt of control signal 130 to energize pump 106.

Assembly 102 includes dispensing assembly 132. Dispensing assembly 132 is connected to pump 106, and the pump is arranged to dispense fluid from supply 124 through dispensing assembly 132. Dispensing assembly 132 includes tube 134 with end 134A connected to output OUT of pump 106. Nozzle 136 is connected to end 134B of tube 134 and is arranged to be connected to protective helmet 138. Pump 106 is arranged to dispense fluid from supply 124 via nozzle 136. Tube 134 and nozzle 136 can be any tube or nozzle, respectively, known in the art.

Pump 106 can be any suitable pump known in the art, for example, any suitable pump operating on direct current (DC) power. In an example embodiment, pump 106 is a 12 volt automotive windshield washer pump. Power supply 110 can be any power supply known in the art, for example, any DC power supply known in the art. In an example embodiment, power supply 110 is a battery pack. Any battery pack known in the art can be used, for example, a 12 volt rechargeable lithium ion battery pack. Transmitter 114 and switch 116 can be any transmitter and switch, respectively, known in the art. In an example embodiment, switch 116 is a single pole, single throw momentary contact switch. Relay 122 can be any relay known in the art. Processor 126 can be any processor known in the art. Some or all of receiver 120, relay 122 and processor 126 can be combined in a single unit.

In an example embodiment, assembly 102 is contained in backpack-like device 142 carried by a user or mounted on vehicle V. Assembly 104 is remote from assembly 102 and is mounted on the vehicle, for example, on handlebars H, so that a user can access switch 116 while keeping both hands on the handlebars. In an example embodiment, assembly 102 includes supply line, or tube, 142 connecting input IN of pump 106 to supply 124. In an example embodiment, tube 134 and supply line 142 include respective quick-disconnects for connection to fluid supply 124, the pump, and the nozzle as required. Tube 142 can be any tube known in the art.

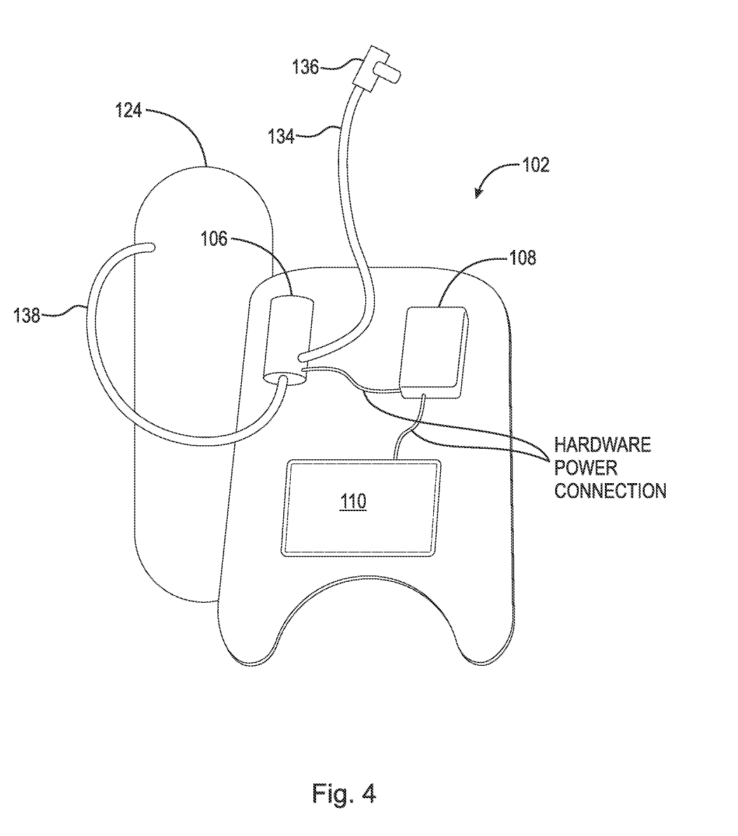

FIG. 4 is a pictorial representation of an example configuration of control assembly 102 shown in FIG. 1. The following should be viewed in light of FIGS. 1 through 4. In an example embodiment control assembly 102 is mounted on backboard 144, which can be inserted in device 140. Note that FIG. 4 is not meant to present every component of system 102 and that other components, such as fuses or couplings, are possible and are not shown.

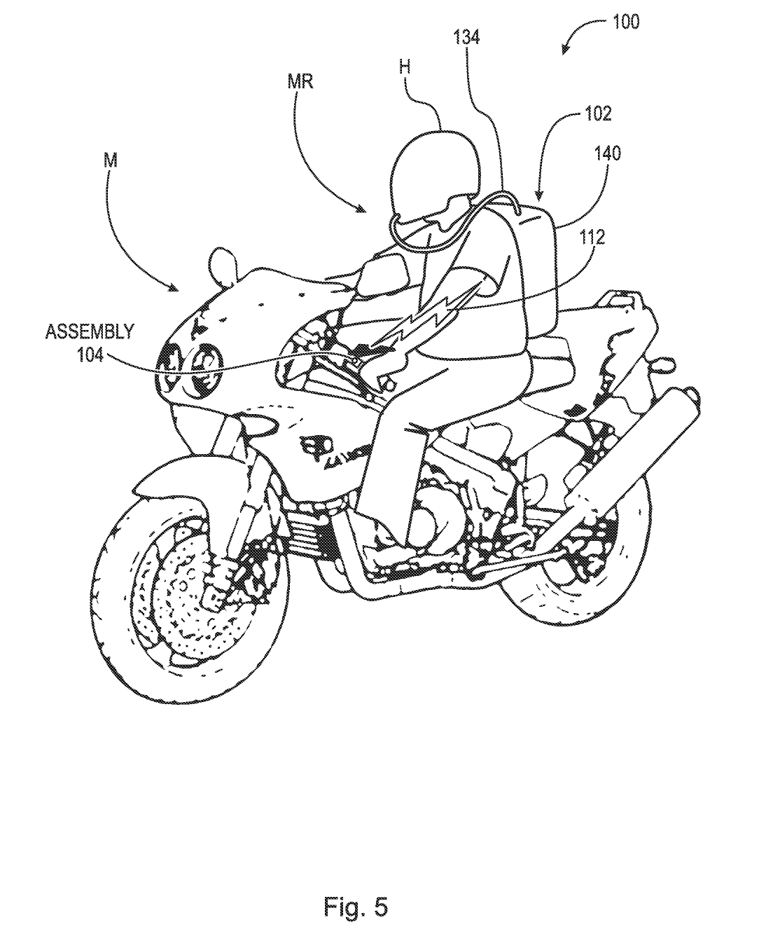

FIG. 5 is a pictorial representation of the system of FIG. 1 in use on a motorcycle rider. In an example usage, motorcycle rider RD carries assembly 102 in device 140 and assembly 104 is mounted to handlebars H of motorcycle M. Nozzle 136 is mounted on helmet 138 worn by the rider such that the nozzle is positioned in front of the mouth of the wearer of the helmet. Then, when the rider wishes for hydration, the rider activates switch 116 while keeping both hands on the handlebar to maintain full control of the motorcycle.

Advantageously, system 100 enables a rider, for example, a motorcycle rider, to obtain hydration whenever desired without the disadvantages noted above. For example, the rider does not need to keep a nozzle in their mouth at all time, which increases the comfort of the rider. Further, since the rider can keep both hands on the handlebars while activating switch 116, the rider can maintain full control of the motorcycle without slowing down. Further still, assembly 104 is separate from assembly 102 and can be installed on handlebars H and left in place. Assembly 102 can then be stored separately, filled with water, or otherwise serviced independent of assembly 104. Nozzle 136 can be mounted to helmet 138 and left in place, in particular, if quick disconnects are used for tube 134. Tube 134 from assembly 102 to the nozzle can be routed to prevent any encumbrance. In addition, system 100 does not include any hardwiring between assemblies 102 and 104, which hardwiring could interfere with operation of the motorcycle.

It will be appreciated that various aspects of the above-disclosed disclosure and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by this disclosure.

What is claimed is:

1. A portable hydration system, comprising:
a first control assembly including:
a pump with an input arranged to connect to a fluid supply;
a control unit configured to:
receive a wireless signal; and, control operation of the pump according to the wireless signal; and,
at least one power supply for the pump and the controller; and,
a second control assembly including:
a wireless transmitter arranged to transmit the wireless signal; and,
a switch arranged:
for mounting on a vehicle; and, to control operation of the wireless transmitter.

2. The portable hydration system of claim 1, wherein the second control assembly is arranged for mounting on the vehicle separate from the first control assembly.

3. The portable hydration system of claim 1, wherein the second control assembly is free of a hardwire connection to the first control assembly.

4. The portable hydration system of claim 1, wherein the control unit includes a wireless receiver configured to receive the wireless signal.

5. The portable hydration system of claim 1, wherein:
the control unit includes a normally open power relay connecting the pump to the power supply; and,
the control unit is configured, upon receipt of the wireless signal, to close the normally open power relay to energize the pump.

6. The portable hydration system of claim 5, wherein:
the control unit includes:
a wireless receiver configured to receive the wireless signal; and, a processor;
the wireless receiver is configured to transmit a first control signal to the processor upon receipt of the wireless signal;
the processor is configured to transmit a second control signal to the normally open power relay upon receipt of the second control signal; and,
the normally open power relay is configured to close upon receipt of the second control signal.

7. The portable hydration system of claim 1, further comprising:
a dispensing assembly connected to the pump, wherein the pump is arranged to dispense the fluid through the dispensing assembly.

8. The portable hydration system of claim 7, wherein:
the dispensing assembly includes:
a tube with:
a first end connected to an output of the pump; and, a second end; and,
a nozzle:
connected to the second end; and, arranged for connection to a protective helmet.

9. A portable hydration system, comprising:
a hydration assembly including:
a fluid supply;
a first control assembly including:
a pump with an input connected to the fluid supply;
a control unit configured to:
receive a wireless signal; and, control operation of the pump according to the wireless signal;
at least one power supply for the pump and the controller;
a dispensing assembly connected to an output of the pump; and, a second control assembly including:
a wireless transmitter arranged to transmit the wireless signal; and, a switch arranged:
for mounting on a vehicle; and, to control operation of the wireless transmitter.

10. The portable hydration system of claim 9, wherein the control unit includes a wireless receiver configured to receive the wireless signal.

11. The portable hydration system of claim 9, wherein:
the control unit includes a normally open power relay connecting the pump to the power supply; and,
the control unit is configured to close the normally open power relay to energize the pump upon receipt of the wireless signal.

12. The portable hydration system of claim 11, wherein:
the control unit includes:
a wireless receiver configured to receive the wireless signal; and, a processor;
the wireless receiver, upon receipt of the wireless signal, is configured to transmit a first control signal to the processor;
the processor is configured to transmit a second control signal to the normally open power relay upon receipt of the second control signal; and,
the normally open power relay is configured to close upon receipt of the second control signal.

13. The portable hydration system of claim 9, wherein:
the dispensing assembly includes:
a tube with:
a first end connected to an output of the pump; and, a second end; and,
a nozzle:
connected to the second end; and, arranged to be connected to a protective helmet; and,
the pump is arranged to dispense the fluid through the nozzle.

14. A portable hydration system, comprising:
a protective helmet;
a first control assembly including:
a pump with an input arranged to connect to a fluid supply;
a control unit configured to:
receive a wireless signal; and, control operation of the pump according to the wireless signal; and,
at least one power supply for the pump and the controller;
a dispensing assembly connected to the pump and the protective helmet; and, a second control assembly including:
a wireless transmitter arranged to transmit the wireless signal; and, a switch arranged:
for mounting on a vehicle; and, to control operation of the wireless transmitter.

15. The portable hydration system of claim 14, wherein the control unit includes a wireless receiver configured to receive the wireless signal.

16. The portable hydration system of claim 14, wherein:
the control unit includes a normally open power relay connecting the pump to the power supply; and,
the control unit is configured to, upon receipt of the wireless signal, close the normally open power relay to energize the pump.

17. The portable hydration system of claim 16, wherein:
the control unit includes:
a wireless receiver configured to receive the wireless signal; and, a processor;
the wireless receiver is configured to transmit a first control signal to the processor upon receipt of the wireless signal;
the processor is configured to transmit a second control signal to the normally open power relay upon receipt of the second control signal; and,
the normally open power relay is configured to close upon receipt of the second control signal.

18. The portable hydration system of claim 14, wherein:
the dispensing assembly includes:
a tube with:
a first end connected to an output of the pump; and, a second end; and,
a nozzle:
connected to the second end; and, connected to the protective helmet.
